(19) United States
(12) Patent Application Publication
(10) Pub. No.: US 2007/0208516 A1
(43) Pub. Date: Sep. 6, 2007

(54) Random forest modeling of cellular phenotypes

(75) Inventors: Vadim Kutsyy, Cupertino, CA (US); Ke Yang, Ossining, NY (US)

Correspondence Address: BEYER WEAVER LLP, P.O. BOX 70250, OAKLAND, CA, 94612-0250, US

(73) Assignee: Cytokinetics, Inc., A Delaware Corporation

(21) Appl. No.: 11/653,109

(22) Filed: Jan. 12, 2007

Related U.S. Application Data
(60) Provisional application No. 60/758,733, filed on Jan. 13, 2006.

(30) Foreign Application Priority Data
Mar. 8, 2006 (GB) 0604663.5

(51) Int. Cl. G06F 19/00

(52) U.S. Cl. 702/19

(57) ABSTRACT

A method of generating classification models to predict biological activity of a population of cells is provided. In certain embodiments, the method involves a) receiving a training set having values for independent and dependent variables associated with populations of cells; b) clustering the training set; c) randomly selecting, with replacement, clusters of cell populations to construct multiple bootstrap samples of the size of the training set; and d) generating a random forest model for each bootstrap sample, wherein the ensemble of random forest models may be used to classify the test population. Also provided are methods of predicting whether a test population of cells exhibits a pathology or biological activity. In certain embodiments, the methods involve applying data about the test population of cells to an ensemble of random forest models. The prediction may be made by aggregating the predictions of the random forest models in the ensemble.

### CROSS-REFERENCE TO RELATED APPLICATIONS

This application claims priority under 35 U.S.C. § 119(e) to U.S. provisional application No. 60/758,733 filed on Jan. 13, 2006 and titled RANDOM FOREST MODELING OF CELLULAR PHENOTYPES, hereby incorporated by reference for all purposes. This application also claims priority under 35 U.S.C. § 119 to Great Britain application No. 0604663.5, filed Mar. 8, 2006 and also titled RANDOM FOREST MODELING OF CELLULAR PHENOTYPES, hereby incorporated by reference for all purposes.

Methods of building models to classify populations of cells based on phenotypic characteristics are provided. In certain embodiments, methods of modeling cellular populations using a random forest algorithm are provided.

In drug discovery, valuable information can be obtained by understanding how a potential therapeutic affects a cell population. Insight may be gained exposing a compound to a stimulus (e.g., a genetic manipulation, exposure to a compound, radiation, or a field, deprivation of required substance, or other perturbation). The ability to quickly determine whether a population of cells exhibits a particular pathology or other classification provides a valuable tool in assessing the mechanism of action of an uncharacterized stimulus that has been tested on the population of cells

Classification models may be used to classify populations of cells using a large number of previously classified cell populations. It would desirable to have a classification model that is able to accurately predict or classify cell populations across a diverse array of stimuli used to treat the cells.

Methods of generating classification models to predict biological activity of a cell or population of cells are provided. In certain embodiments, the methods involve a) receiving a training set having values for independent and dependent variables associated with populations of cells; b) clustering the training set such that clusters of the populations of cells are produced, each containing values for independent and dependent variables for its cell populations; c) randomly selecting, with replacement, clusters of cell populations to construct multiple bootstrap samples of the size of the training set; and d) generating a random forest model for each bootstrap sample, wherein an ensemble of the random forest models is provided to classify the test population. Also provided are methods of predicting whether a test population of cells exhibits a pathology or biological activity. In certain embodiments, the methods involve applying data about the test population of cells to an ensemble of random forest models. The prediction may be made by, e.g., averaging or taking the majority vote of the predictions of the ensemble of random forest models.

### BRIEF DESCRIPTION OF THE DRAWINGS

FIG. 1 is a flowchart depicting one method for producing a model that can be used to classify a population of cells.

FIG. 2 is a schematic illustrating a rough example of training set data.

FIG. 3 is a flowchart depicting one method for building a random tree model.

FIG. 4A is a schematic illustrating a rough example of a partially-grown random tree model.

FIG. 4B is a schematic illustrating variable selection for a node of a random tree model.

FIG. 5 is a flowchart depicting one method for using a random tree ensemble to predict a classification for a test population of cells.

Methods for building models to determine whether a cell or cell population exhibits a certain pathology or biological activity are provided. In certain embodiments, the methods for building a model involve creating decision trees based on an original data set containing independent variables associated with cell populations (e.g., intensity and morphological features of markers located within the cells) and a dependent variable that classifies the cell based on the independent variables. An example of such classification is a pathology such as cholestasis or steatosis. In accordance with certain embodiments, the independent variables are cellular phenotype features obtained by image analysis.

In certain embodiments, the models may be built using the random forest algorithm, in which bootstrap techniques are combined with random variable selection to grow multiple decision trees. These multiple decision trees are sometimes referred to herein as an ensemble of trees or the random forest. Information about independent variables of a test cell population may then be applied to the ensemble of trees to obtain a prediction or classification about the test population. The prediction or classification is made by averaging or by taking a majority vote of the predictions of all the trees in the ensemble.

Bootstrap samples are used to generate the ensemble of decision trees. According to certain embodiments, the methods provided involve clustering the training set prior to selecting the bootstrap samples. The data set may be clustered by compound, cell line, or other parameter. Clustering improves the robustness of the model.

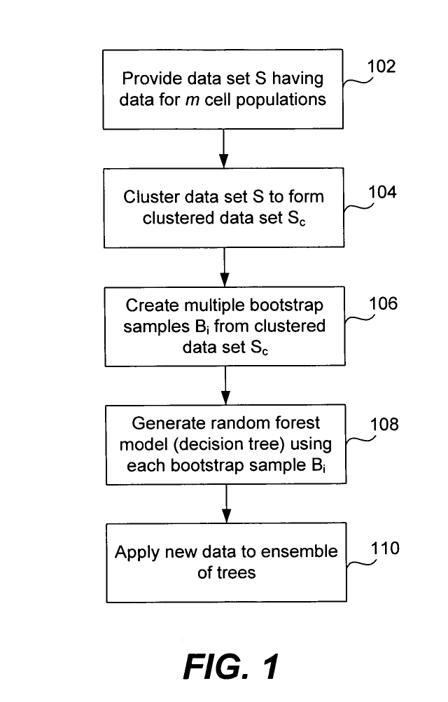

A method of building a model for classifying a population of cells according to certain embodiments is presented in FIG. 1. FIG. 1 presents an overview of the process; various aspects of the method shown in FIG. 1 are discussed in greater detail below. As shown here, a method 100 begins at block 102 where an original data set S having data about m cell populations is provided. The data set may also be referred to as a training set. In certain embodiments, the training set includes biological classification and phenotypic features (dependent and independent variables values) for all cell populations across all compounds, concentrations, replicates, cell lines, etc. For example, each data point in the set may correspond to a population of cells in a well treated with a certain compound at a certain concentration and the well information associated for that well. In block 104, the data set S is clustered to form a clustered data set S_{c}. Clustering the data set involves grouping data points based on a shared parameter. For example, if data points are clustered by compound, all data points corresponding to compound a are put in cluster a, all data points corresponding to compound b are put in cluster b, etc.

In certain embodiments, the data set is stratified in addition to clustered. In certain embodiments, the data set is stratified by pathology. For example, in building a model for classifying cells as exhibiting cholestasis or not, the data set may stratified by dividing the data set into populations treated with compounds that are known to induce cholestasis (at any concentration) and those that do not. Thus, if compounds a and b are annotated as cholestasis compounds but compounds c and d are not, the population corresponding to compounds a and b put into the first stratum, and the population corresponding to compounds c and d are put into the second stratum. Stratification allows the bootstrap samples that are created to contain the same proportion of cell populations that are classified as exhibiting a pathology as the original data set. As a result these models are more representative.

From the clustered data set S_{c}, multiple bootstrap samples Bᵢ are created in block 106. Each of these is obtained by sampling, with replacement, from the clustered data set to create a new set with m members. The “with replacement” condition produces variations on the original set S. A bootstrap sample, Bᵢ, will sometimes contain replicate samples from S and lack certain samples originally contained in S. Also, because the data set is clustered, selecting a cluster insures all data points in that cluster will be contained in the bootstrap sample Bᵢ. This is in contrast to conventional bootstrapping methods, which sample from the original unclustered data set, with replacement, to form the bootstrap samples. Clustering the data set increases the likelihood that a particular cluster will not be represented in a bootstrap sample Bᵢ. This feature makes the resulting model more robust. Without clustering, there is a high chance that some of the points from each cluster will be in every model. Each point is similar to the points in its cluster. The unequal selection of similar points creates overfitting and makes model less robust. Thus clustering the data set makes the model more robust.

It should be noted that when the data set is stratified, each bootstrap sample is obtained by sampling, with replacement, from each stratum such that the ratio of the sizes of the strata (in terms of number of clusters) is the same as in the original data set. Clustering is done within strata.

At a block 108, an unpruned decision tree is built for each bootstrap sample Bᵢ in accordance with the random forest algorithm. As discussed further below, at each node of the tree, a subset of independent variables are randomly sampled and tested to determine how well it predicts the dependent variable at the current node. The variable providing the best result is then taken from this subset. In this manner, an unpruned tree is grown for each bootstrap sample Bᵢ. The ensemble of all the trees, i.e. the forest, makes up a model that may be applied to data to predict cell population classification. In block 110, the model may be applied to new data, e.g. a test population of cells. This is done by applying the dependent variables associated with the test population of cells to all the trees in the random forest ensemble. A prediction or classification is then made by averaging the predictions from all of the trees.

The original data set, also called a training set contains all data relating to cell populations. The training set includes all dependent and independent variables values for all cells or cell populations across all compounds, concentrations, replicates, cell lines, etc.

The term “cell population” is used interchangeably with “population of cells.” A population of cells may include one or more cells. In certain embodiments, a population of cells is the cells in a well on a plate and referred to as a well. In certain embodiments, a population of cells is the cells in a field of view taken from an image of cells in a well or other support medium.

The independent variables associated with each cell population are generally phenotypic properties of the population of cells. The independent variables may also be referred to as descriptors or features. Often these are obtained from images of cell populations and subsequent image analysis. The choice of descriptors or features for use in a model depends on the biological condition being modeled. Numerous descriptors are known to be useful in predicting a condition or classifying a stimulus. Some of these are described in the following patent documents, each of which is incorporated herein for all purposes: U.S. Pat. No. 6,876,760 titled CLASSIFYING CELLS BASED ON INFORMATION CONTAINED IN CELL IMAGES, US Patent Publication No. 20020144520 titled CHARACTERIZING BIOLOGICAL STIMULI BY RESPONSE CURVES, US Patent Publication No. 20020141631 titled IMAGE ANALYSIS OF THE GOLGI COMPLEX, U.S. Pat. No. 6,956,961 titled EXTRACTING SHAPE INFORMATION CONTAINED IN CELL IMAGES, US Patent Publication No. 20050014131 titled METHODS AND APPARATUS FOR INVESTIGATING SIDE EFFECTS, US Patent Publication No. 20050009032 titled METHODS AND APPARATUS FOR CHARACTERISING CELLS AND TREATMENTS, US Patent Publication No. 20050014216 titled PREDICTING HEPATOTOXICITY USING CELL BASED ASSAYS, and US Patent Publication No. 20050014217, also titled PREDICTING HEPATOTOXICITY USING CELL BASED ASSAYS, U.S. Provisional Patent Application No. 60/509,040, filed Jul. 18, 2003 and titled CHARACTERIZING BIOLOGICAL STIMULI BY RESPONSE CURVES, U.S. patent application Ser. No. 11/098,020, filed Apr. 1, 2005 and titled METHOD OF CHARACTERIZING CELL SHAPE, U.S. patent application Ser. No. 11/155,934, filed Jun. 16, 2005 and titled CELLULAR PHENOTYPE, U.S. patent application Ser. No. 11/192,306, filed Jul. 27, 2005 and titled CELL RESPONSE ASSAY EMPLOYING TIME-LAPSE IMAGING and U.S. patent application Ser. No. 11/082,241, filed Mar. 15, 2005 and titled ASSAY FOR DISTINGUISHING LIVE AND DEAD CELLS. General examples of descriptors are intensity, location, population size, morphological, concentration, and/or statistical values obtained by analyzing a cell image showing the positions and concentrations of one or more markers bound within the cells. The phenotypic characterizations may also be derived in whole or in part by techniques other than image analysis.

Also associated with each cell population are one or more dependent variables. In certain embodiments, a dependent variable may be a yes/no or other binary classification that indicates whether or not the cell population exhibits a certain pathology or other biological activity. Examples of pathologies include cholestasis, phospholipidosis and steatosis. Examples of other binary classifications include whether a cell in the cell population is live or dead and whether a stimulus has off-target effects, etc. Examples of non-binary classifications that provide state-based classifications include where in the cell cycle a particular cell currently resides, the mechanism of action of a particular stimulus such as a compound, etc. In certain embodiments, the dependent variable may be a number, for example indicating a percent activity or inhibition or a predictive score. For purposes of discussion, the independent and dependent variables for each population of cells may be referred to herein as the well information.

In certain embodiments, training set contains information about stimuli applied to the cell populations. In certain embodiments, stimuli are compounds, but stimuli also include materials, radiation (including all manner of electromagnetic and particle radiation), forces (including mechanical (e.g., gravitational), electrical, magnetic, and nuclear), fields, thermal energy, and the like. General examples of materials that may be used as stimuli include organic and inorganic chemical compounds, biological materials such as nucleic acids, carbohydrates, proteins and peptides, lipids, various infectious agents, mixtures of the foregoing, and the like. Other general examples of stimuli include non-ambient temperature, non-ambient pressure, acoustic energy, electromagnetic radiation of all frequencies, the lack of a particular material (e.g., the lack of oxygen as in ischemia), temporal factors, etc.

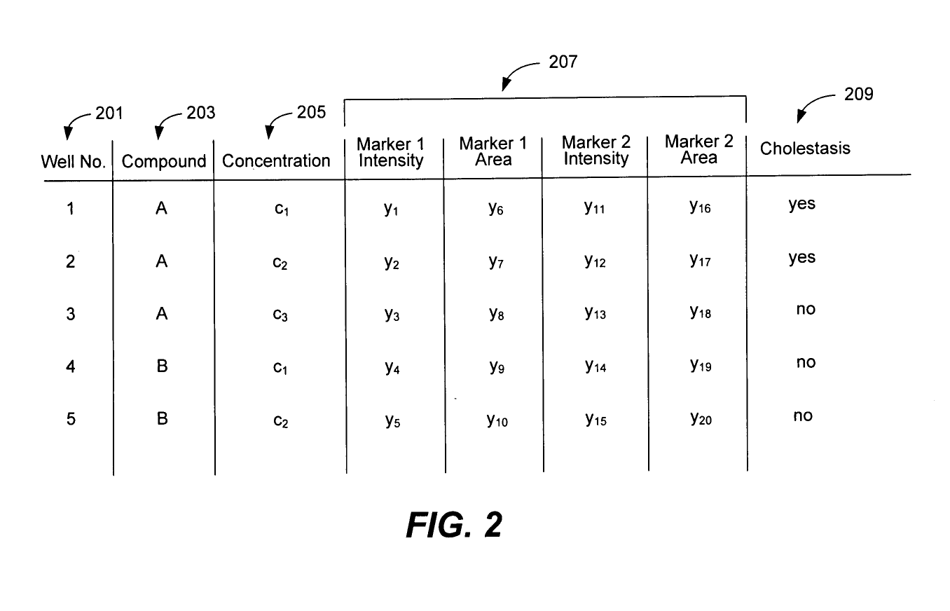

FIG. 2 shows a simple example of training set data. Reference number 201 indicates the cell populations; in the example shown in FIG. 2, the cell populations are wells on a plate. Each cell population is treated with a compound (203) at a concentration c (205). Reference number 207 indicates the independent variables, in this example, the intensity and area of two markers. Reference number 209 indicates the dependent variable, in this case, whether the cell population exhibits cholestasis or not. A compound may induce a pathology at all concentrations, only at certain concentrations, or not at all. In certain embodiments, the training set data may indicate whether the compound induces a pathology at a particular concentration; in other embodiments, the training set data may indicate only whether the compound induces the pathology without any indication of the concentrations at which it induces the pathology. In the later case, all cell populations treated with a compound will have the same dependent variable value.

In certain embodiments, the training set may contain replicate data points. For example, compound A may be used to treat three cell populations at each concentration. If there are ten concentrations, the compound is represented by thirty points (10 concentrations times 3 replicates).

Although the example shown in FIG. 2 contains information about compounds, the training set may contain information about other parameters instead of or in addition to information about compounds (or other stimuli). For example, in certain embodiments, the data set contains information about cell lines.

The number of independent variables may range from 1 to thousands. For example, in one embodiment, a model for classifying cholestasis uses around 1000 independent variables. Models may use significantly fewer variables, for example, in another embodiment, a model for phospholipidosis uses four independent variables. Examples of models for classifying cells are described in above-referenced U.S. Pat. Nos. 6,876,760 and 6,956,961, US Patent Publication Nos. 20020141631 and 20050014131 and U.S. patent application Ser. No. 11/082,241. Methods of classifying cell as exhibiting certain hepatotoxic pathologies including necrosis, cholestasis, steatosis, fibrosis, apoptosis, and cirrhosis are described in above-referenced US Patent Publication Nos. 20050014216 and 20050014217. All of these references are hereby incorporated by reference for all purposes.

In certain embodiments, methods provided herein use bootstrapping techniques. Bootstrapping methods involve generating bootstrap samples from an original data set. These bootstrap samples may then be used to generate models of various forms, with decision trees being one example. Bootstrap samples are created by sampling, with replacement, from an original data set to create a new data set (a bootstrap sample) of the same size as the original data set. In the methods provided herein, the bootstrap samples are used to generate random forest models. Bootstrap methods have been shown to improve the robustness of tree models and allow additional analysis of the model (such as variable selection and estimation of the future performance of the model).

In conventional bootstrap techniques, the bootstrap sample is selected by sampling, with replacement, individual data points from the original data set. In certain embodiments of methods provided herein, however, the data set is clustered prior to generating the bootstrap samples. Referring back to FIG. 1, in block 104, the original data set or training set S is clustered to create clustered data set Sc prior to generating the multiple bootstrap samples in block 106. Clustering involves grouping cell populations by a parameter or characteristic. In certain embodiments, the cell populations are clustered by stimulus, for example by compound. Thus, all cell populations treated with compound a will be in cluster a, all cell populations treated with compound b will be in cluster b, etc. The bootstrap samples are built by randomly sampling clusters, with replacement, to build a sample of the size of the original data set (in terms of number of clusters) or another predetermined sample size. For example, if the original data set contains 100 members, and each cluster has 10 members, building each bootstrap sample involves selecting 10 clusters from the clustered data set. Each cluster may be of different size.

As indicated above, in certain embodiments, the data set is stratified in addition to clustered. The bootstrap samples are then built by randomly sampling clusters, with replacement, within each stratum. In this manner, each bootstrap sample has the same proportion of clusters belonging a particular stratum as the original data set. For example, if there are 400 compounds known to induce cholestasis, 100 compounds that do not induce cholestasis, the data may be divided into strata, the first stratum containing 400 compounds and the second containing 100. The data set may then be clustered within each stratum prior to bootstrap sampling.

In addition to pathology, the data set may also be stratified by other parameters, such as chemical properties. Also in certain embodiments, the data set may be sub-stratified. For example, cell populations not exhibiting cholestasis may be further stratified by another pathology or chemical properties, such as exhibiting or not exhibiting steatosis, being part of chemical series or other parameters. Also as indicated above, in cases in which stratification is performed, the bootstrap samples are built by random sampling of clusters within each strata. In this manner, the ratio of the sizes of the strata is maintained. For example, if the data set is stratified by pathology, each bootstrap sample will contain the same proportion of positive (pathology inducing) to negative compounds as the original data set.

Because the bootstrap samples are built by random sampling of clusters, the likelihood that a particular compound will not be represented in a bootstrap sample (and corresponding random forest model) is greatly increased and equal to 1/e˜=32.7%. For example, if a training set contained 100 wells treated with 10 different compounds, a random sampling of individual wells, with replacement, would almost surely have representatives of each compound. Bootstrap samples generated according the methods of the present, however, are far likelier not to contain any wells treated with a particular compound. This is important because the resulting models are more robust, that is they are able to accurately predict classifications for cells treated with a diverse array of compounds in the future data (or predict classifications for a diverse array of whatever parameter is used to cluster).

In certain embodiments, the methods provided herein use a random forest algorithm to generate models. Random forest algorithms use bootstrap samples to generate individual decision trees. The trees are grown by selecting a random subsample of the independent variables at each node and selecting the variable that produces the best outcome.

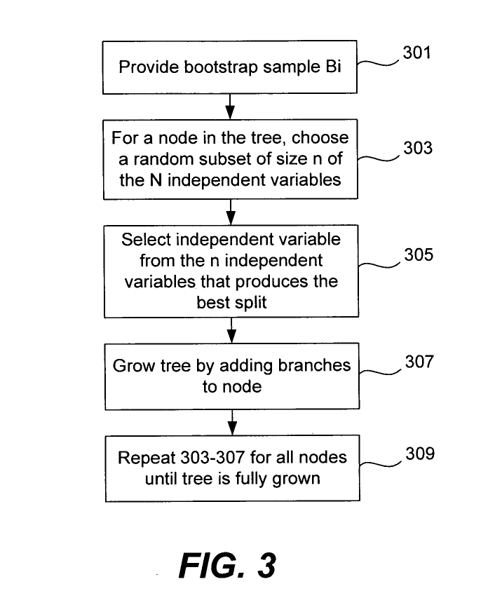

FIG. 3 is flow chart illustrating steps in generating a decision tree according to the random forest algorithm. In block 301 a bootstrap sample Bᵢ is provided. The bootstrap sample is generated as discussed above with regard to block 106 of FIG. 1. The bootstrap sample contains data for m wells (which are selected by virtue of belonging to selected clusters), each associated with N independent variables. In block 303, a random subset of size n of the N independent variables is chosen. The variable on which to base the decision at the first node will be chosen from this subset. At block 305, the variable of the n randomly selected variables that produces the best result is selected. The best result is the result that most accurately predicts the known dependent variable. This is determined by considering the relationships between each of the n randomly selected independent variables and the dependent variable within the well information of the bootstrap sample. At block 307, the tree is grown by basing the decision at that node on the chosen variable and adding branches, each of which provides a new decision (node). This method is repeated at block 309 for all nodes. The tree is grown until each of the nodes contains only a single class, i.e. a prediction of 100%.

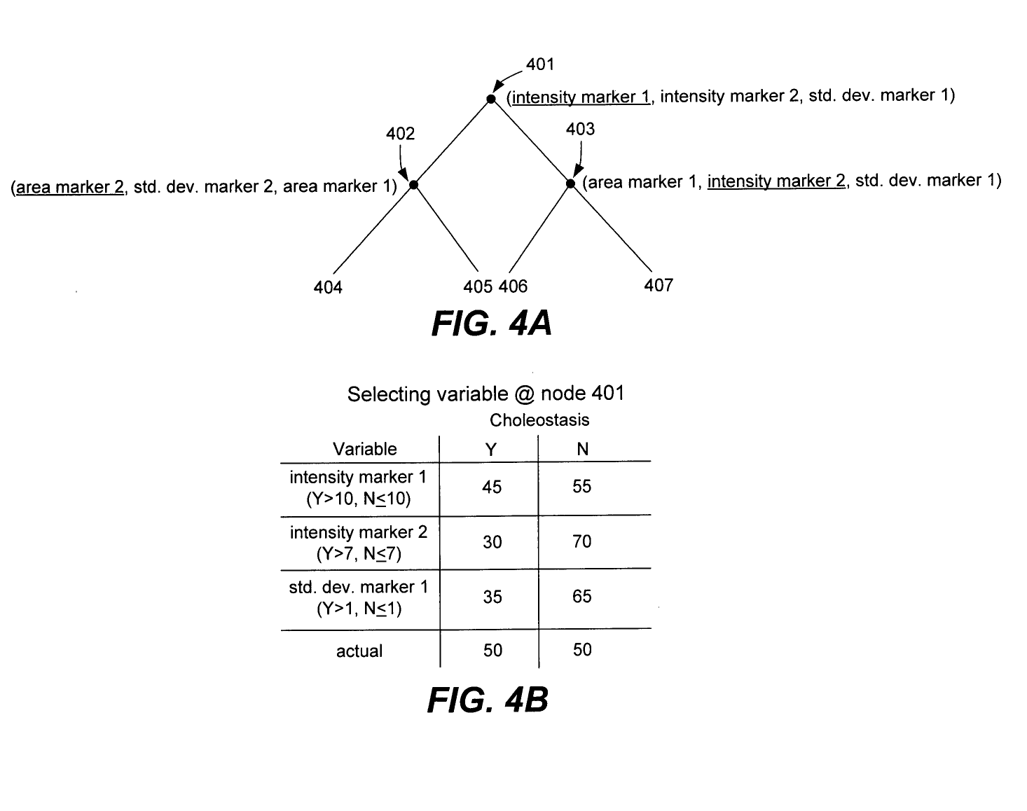

An example of the process described in FIG. 3 is illustrated in FIGS. 4A and 4B. In this example, there are 6 independent variables associated with each well in the bootstrap sample: the intensity of marker 1, the intensity of marker 2, the standard deviation of the intensity of marker 1, the standard deviation of the intensity of marker 1, the standard deviation of the intensity of marker 2, the area of marker 1 and the area of marker 2. The bootstrap sample contains the values of these independent variables for all wells. The bootstrap sample also contains the values of the dependent variable, in this example whether the cells in the well exhibit cholestasis or not. In this example, the size n of the random subset of independent variables is 3. Thus, 3 of the variables are randomly selected for the first node, in FIG. 4A, node 401. In this example, intensity of marker 1, intensity of marker 2, and standard deviation of marker 1 are the variables randomly selected for node 401. Each of these variables is then tested to find the one that best predicts the known outcomes. FIG. 4B shows results of testing each of the randomly selected variables. Applying decision criteria for the first variable, the intensity of marker 1 (Y if >10, N if ≦10), to the bootstrap sample predicts that cells in 45 wells exhibits cholestasis and 55 do not. Decision criteria for the other selected variables is applied as well. As can be seen in FIG. 4B, the prediction made by basing the decision on intensity of marker 1 is closest to the actual results; thus this variable is chosen as the variable on which to base the decision at node 401 in the model. This is indicated in FIG. 4A by the line under the selected variable. Other cost functions such as the Gini index may be also used for tree building. The tree is then grown, producing two more nodes, nodes 402 and 403. The process of randomly selecting a subset of variables and selecting the best variable on which to base decision is repeated for these nodes. The data is filtered through the previous nodes prior to selecting the best variable; for example selecting the best variable at node 402 is based only on the 45 wells that were predicted “Y” at node 401. The tree is grown, producing nodes 404-407 as shown. Steps 305-307 are repeated to grow the tree. The tree is considered complete or grown when each of the nodes contains only a single class, i.e. a prediction of 100%.

FIGS. 4A and 4B illustrate generating a decision tree for a single bootstrap sample. Referring back to FIG. 1, block 108, a decision tree or random tree model is grown for each of the bootstrap samples. The ensemble of these trees (i.e., the forest) may be then be used to classify cell populations based on the values of the independent variables associated with them.

The number of bootstrap samples and random forest models may be determined by applying new data as discussed below to the ensemble of random forest models and determining if the results from the ensemble have converged.

The number n of independent variables in subset may range from 1 to almost any number. The number of independent variables is not defined by the model. However, a very large number of independent variables may contribute to instability of the model.

Further details of random forest algorithms may be found in Leo Breiman, “Random Forests—Random Features,” Technical Report 567, University of California, Berkeley, September 1999, which is hereby incorporated by reference.

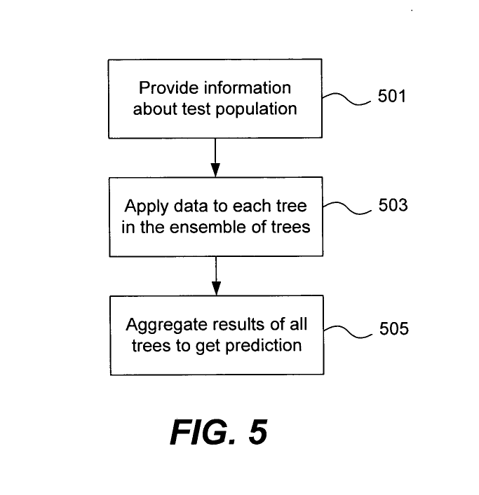

The models generated as described above may be used to classify a cell or population of cells based on the phenotypic characteristics of the cells. FIG. 5 is a flowchart illustrating steps in applying a model to classify a test cell or population of cells according to certain embodiments. The process begins at block 501 in which information about the test population is provided. The information includes values of independent variables of the test population. The independent variables are the same as those used to generate the model as described above, and in certain embodiments, describe phenotypic characteristics of the population. (Unlike the data provided in the training set, the dependent variable (e.g., does the cell exhibit cholestasis or not) is not known for the population of cells—this is what the model determines.) In block 503 the data is applied to each tree in the ensemble of trees generated as discussed above with regard to FIGS. 1 and 4. Each tree produces a result or prediction. In certain embodiments, the prediction is binary (yes/no) indicating that the population of cells exhibit or do not exhibit the pathology or classification of interest. In certain embodiments, the result is a numeral indicator of the pathology or classification. In block 505, the predictions of all the trees are aggregated. In certain embodiments, the predictions are aggregated by majority vote (e.g. for binary classification). In certain embodiments, the predictions are aggregated by averaging (e.g. for numerical predictions). The aggregate of the predictions of the trees is the result or prediction for the test population.

Methods, devices, systems and apparatus provided herein can be implemented in digital electronic circuitry, or in computer hardware, firmware, software, or in combinations of them. Apparatus can be implemented in a computer program product tangibly embodied in a machine-readable storage device for execution by a programmable processor; and aspects of the methods provided can be performed by a programmable processor executing a program of instructions to perform, e.g., clustering training set data, generating random forest models from clusters of training set data, operating on input data (e.g., images in a stack), extracting cellular phenotypic features from images, predicting outcomes and/or classifying responses (e.g., mechanisms of action for certain compounds) using models having as inputs phenotypic characteristics of cells, identifying cellular boundary regions, and other processing algorithms.

Methods provided herein can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, methods can be implemented on a computer system having a display device such as a monitor or LCD screen for displaying information to the user. The user can provide input to the computer system through various input devices such as a keyboard and a pointing device, such as a mouse, a trackball, a microphone, a touch-sensitive display, a transducer card reader, a magnetic or paper tape reader, a tablet, a stylus, a voice or handwriting recognizer, or any other well-known input device such as, of course, other computers. The computer system can be programmed to provide a graphical user interface through which computer programs interact with users.

Finally, the processor optionally can be coupled to a computer or telecommunications network, for example, an Internet network, or an intranet network, using a network connection, through which the processor can receive information from the network, or might output information to the network in the course of performing the above-described method steps. Such information, which is often represented as a sequence of instructions to be executed using the processor, may be received from and outputted to the network, for example, in the form of a computer data signal embodied in a carrier wave. The above-described devices and materials will be familiar to those of skill in the computer hardware and software arts.

It should be noted that methods and other aspects provided may employ various computer-implemented operations involving data stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that may form part of the methods described are useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered however, that all of these and similar terms are to be associated with the appropriate physical quantities and are merely convenient labels applied to these quantities.

Also provided are devices, systems and apparatus for performing the aforementioned operations. The system may be specially constructed for the required purposes, or it may be a general-purpose computer selectively activated or configured by a computer program stored in the computer. The processes presented above are not inherently related to any particular computer or other computing apparatus. Various general-purpose computers may be used with programs written in accordance with the teachings herein, or, alternatively, it may be more convenient to construct a more specialized computer system to perform the required operations.

Although the above has provided a general description according to specific processes, various modifications can be made without departing from the spirit and/or scope of the description provided. Those of ordinary skill in the art will recognize other variations, modifications, and alternatives.

What is claimed is:

1. A method of generating a model for classifying of a test population of cells based on one or more dependent variables, comprising:
a) receiving a training set comprising values for independent and dependent variables associated with populations of cells;
b) clustering the training set such that clusters of the populations of cells are produced, each containing values for independent and dependent variables for its cell populations;
c) randomly selecting, with replacement, clusters of cell populations to construct multiple bootstrap samples of the size of the training set; and
d) generating a random forest model for each bootstrap sample, wherein an ensemble of the random forest models is provided to classify the test population.

2. The method of claim 1 wherein generating a random forest model comprises growing an unpruned decision tree by randomly selecting a subset of independent variables at each node and choosing the variable that produces the best split for that node.

3. The method of claim 1 wherein the training set is clustered by stimulus applied to the cell populations.

4. The method of claim 1 wherein the training set is clustered by compound applied to the populations of cells.

5. The method of claim 1 wherein the training set is clustered by cell line.

6. The method of claim 1 wherein the dependent variable indicates at least one of: whether the population of cells exhibits a pathology, whether the population of cells is live or dead, whether a stimulus applied to the population of cells has off-target effects, where in the cell cycle the population of cells currently resides and the mechanism of action of a particular stimulus applied to the population of cells.

7. The method of claim 6 wherein the dependent variable indicates whether the population of cells exhibits a pathology.

8. The method of claim 7 wherein the dependent variable indicates whether the population of cells exhibits at least one of cholestasis, phospholipidosis and steatosis.

9. The method of claim 1 wherein the independent variables comprises at least one of: the intensities of marker within the population of cells, the distribution of the intensities of a marker within the population of cells and the areas of a marker within the population of cells.

10. The method of claim 1 wherein the independent variables comprises information about the morphological characteristics of cells in the population of cells.

11. The method of claim 10 wherein the independent variables comprises information from ellipse-fitting of the cells in the population, said information comprising at least one of axes ratios, eccentricities and diameters.

12. A method of predicting a pathology or biological activity of a test population of cells, the method comprising:
a) providing a model generated according to claim 1;
b) applying the independent variables to the ensemble of trees to produce multiple predictions; and
c) aggregating the predictions.

13. A computer program product comprising a machine readable medium on which is provided program instructions for classifying of a test population of cells based on one or more dependent variables, the program instructions comprising:
a) code for receiving a training set comprising values for independent and dependent variables associated with populations of cells;
b) code for clustering the training set such that clusters of the populations of cells are produced, each containing values for independent and dependent variables for its cell populations;
c) code for randomly selecting, with replacement, clusters of cell populations to construct multiple bootstrap samples of the size of the training set; and
d) code for generating a random forest model for each bootstrap sample, wherein an ensemble of the random forest models is provided to classify the test population.

14. The computer program product of claim 13 wherein (d) comprises code for growing an unpruned decision tree by randomly selecting a subset of independent variables at each node and choosing the variable that produces the best split for that node.

15. The computer program product of claim 13 wherein the training set is clustered by stimulus applied to the cell populations.

16. The computer program product of claim 13 wherein the training set is clustered by compound applied to the populations of cells.

17. The computer program product of claim 13 wherein the training set is clustered by cell line.

18. The computer program product of claim 13 wherein the dependent variable indicates at least one of: whether the population of cells exhibits a pathology, whether the population of cells is live or dead, whether a stimulus applied to the population of cells has off-target effects, where in the cell cycle the population of cells currently resides and the mechanism of action of a particular stimulus applied to the population of cells.

19. The computer program product of claim 13 wherein the dependent variable indicates whether the population of cells exhibits a pathology.

20. The computer program product of claim 19 wherein the dependent variable indicates whether the population of cells exhibits at least one of cholestasis, phospholipidosis and steatosis.

21. The computer program product of claim 13 wherein the independent variables comprises at least one of: the intensities of marker within the population of cells, the distribution of the intensities of a marker within the population of cells and the areas of a marker within the population of cells.

22. The computer program product of claim 13 wherein the independent variables comprises information about the morphological characteristics of cells in the population of cells.

23. The computer program product of claim 13 wherein the independent variables comprises information from ellipse-fitting of the cells in the population, said information comprising at least one of axes ratios, eccentricities and diameters.
